(19) United States
(12) Patent Application Publication
(10) Pub. No.: US 2017/0215235 A1
(43) Pub. Date: Jul. 27, 2017

(54) A COOKING DEVICE HAVING AN ELECTRICAL TRANSMISSION ELEMENT

(71) Applicant: BSH Hausgeräte GmbH, Munich (DE)

(72) Inventors: Engin Atalay, TEKIRDAG (TR); Sevgi Cosar, ISTANBUL (TR); Gürkan Gündogdu, TEKIRDAG (TR); Hasan Emrah Torun, ISTANBUL (TR)

(21) Appl. No.: 15/326,660

(22) PCT Filed: Jul. 8, 2015
(86) PCT No.: PCT/EP2015/065531

§ 371 Date: Jan. 17, 2017

(30) Foreign Application Priority Data
Jul. 25, 2014 (TR) 2014/08916

(51) Int. Cl. H05B 3/16; H05B 3/68; F24C 7/08

(52) U.S. Cl. CPC H05B 3/16; F24C 7/083; F24C 7/088; H05B 3/688

(57) ABSTRACT

A cooking device includes a body, at least one functional element which is positioned on the body; and a ceramic-based panel which is positioned on the outer section of the body. At least one conductive strip is directly passed through the ceramic-based panel so as to transmit electricity to the functional element through the ceramic-based panel. The conductive strip can be electrically positively or negatively charged. The functional element may be a motor or an illumination element which can function at low voltage.

The present invention relates to cooking devices having an electrical transmission mechanism which provides power to a functional element like a LED lamp, which operates by using electrical energy, by means of electrical transmission.

Cooking devices can be in the form of a standalone cooktop or an oven with cooktop having a cooktop integrated to an oven. Said cooktops have a cover which provides covering while the cooktop is not in use or which is kept open while the cooktop is in use. The cover is in general manufactured from ceramic materials and particularly it is manufactured from glass materials. In the same manner, the oven part of the cooking device also has a door. The door is in general manufactured from glass material, and insulation is provided on the door.

In general, cables are used for transmitting the electrical energy from one point to another point on cooking devices. The electrical power, applied from a power supply, is in general transmitted by means of electrical cables to a functional element which is to be operated by means of electrical power. One of the examples of these embodiments can be seen in the patent document with publication number JP2009070714. In said invention, a heating cooking device comprises a connecting cable in which a plurality of signal lines are provided and which is electrically connected to an operation unit having a control unit which controls cooking.

For providing safety, the installation and transport of the cables inside the cooking device or on the cooking device cannot be realized in an exposed form. The cables are coated by means of insulator materials for preventing easy access to the cables and since temperature increases occur, and moreover, in some embodiments, the cable is placed into carrier profiles. By means of this, the safety of the cables is provided, and also the safety of the electrical mechanism is provided.

The object of the present invention is to provide an electrical transmission element which provides electrically safe electrical transmission and also which preserves the aesthetic appearance of the cooking device, without the need for additional elements like a cable and a carrier profile which provides cable safety.

In order to realize said object, the present invention relates to a cooking device comprising a body; at least one functional element positioned on the body; and a ceramic-based panel positioned on the outer section of the body. The cooking device comprises at least one conductive strip which is directly passed through the ceramic-based panel so as to transmit electricity to the functional element through the ceramic-based panel. Thus, electricity is transmitted to a functional element positioned on or in the vicinity of the ceramic-based panel. While electrical transmission is provided, at the same time, the aesthetical appearance is preserved, since no cable is used on the ceramic panel which is a visible section of the cooking device.

The conductive strips are selected from metal materials which are electrically conductive. The functional element can be a motor, a sensor, signal or illumination element which function at low voltage. The ceramic-based panels may be a door section of a cooking chamber of the cooking device or they may be a cover section of a cooktop thereof.

In a probable embodiment of the present invention, each conductive strip is electrically positively or negatively charged.

In a probable embodiment of the present invention, the cooking device comprises at least one positively charged strip and at least one negatively charged strip connected to the functional element so as to complete an electrical circuit. Thus, the conductive strips provide operation of the functional element.

In a probable embodiment of the present invention, the voltage value, applied through the conductive strips, is between 0 and 60 volts. Thus, low voltage power is transmitted which is needed for the operation of the functional element.

In another probable embodiment of the present invention, the cooking device comprises an electronic card connected to the conductive strip so as to transmit electrical current to at least one conductive strip and converting the current from AC to DC. Thus, in cases where AC current is not desired to be utilized directly, the AC current can be converted to DC current by means of the electronic card.

In a probable embodiment of the present invention, the current passing through the conductive strips is DC. Thus, the current, provided by a direct current source or direct current converter, can be directly utilized.

In another probable embodiment of the present invention, the conductive strips are made of metal material comprising Ag ion. Thus, a material is used whose conductivity coefficient is suitable for the required electricity transmission. Moreover, the strips, whose Ag ion is conductive, can be formed by applying paint onto the ceramic-based panel.

In another probable embodiment of the present invention, there are one each insulator layers, which are resistant to abrasion, on the conductive strips. In case AC current is used, the conductive strips shall be insulated. Thanks to the insulator layer, the insulation of the conductive strip is realized. The insulator layer can be formed by means of usage of a special insulation material in strip form, or by means of painting the conductive strip with insulator paint.

In another probable embodiment of the present invention, the conductive strips comprise one each decorative layers thereon. Thus, the conductive strip is painted in the desired color and pattern, and a visually good design can be obtained.

In another probable embodiment of the present invention, the functional element is an illumination element. Thus, power is provided to an illumination element provided on the cooking device. The illumination element can be a LED.

In another probable embodiment of the present invention, the cooking device comprises a triggering element which turns on/off the functional element. Thus, the functional element can be controlled.

The triggering element may be a touch-button or a mechanical button. Or it may be an element which functions by means of audible commands.

In another probable embodiment of the present invention, a cross section of the conductive strip can be varied in an inversely proportional manner with the voltage on the conductive strip and the conductivity coefficient of the conductive strip; and in a directly proportional manner with a distance through which power and electrical current are desired to be transmitted. Thus, the conductive strip can be formed so as to obtain different designs by providing minimum required cross sectional area. The conductive strip can be formed in the form of a pattern on the ceramic-based panel.

In order to realize said object, the present invention is a method related to passage of electrical current through a ceramic-based panel of the cooking device. In said method, there is the method step of coating the upper section of the ceramic-based panel by means of at least one metallic conductive strip. Thus, electricity is transmitted to any type of functional element, which operates by means of electrical power, through the conductive strip.

In a possible application of the present invention, there is the method step of coating the ceramic-based panel by means of at least one negatively charged conductive strip and at least one positively charged conductive strip, having electrical conductivity, by leaving a clearance between said conductive strips so as to transmit electrical energy to a functional element positioned on the cooking device. Thus, the contact between the conductive strips and thereby short-circuit are prevented.

In another possible application of the present invention, there is the method step of applying the conductive strip onto the ceramic-based panel in the form of a paint. Thus, conductive strips can be easily formed on the ceramic-based panel.

In another possible application of the present invention, there is the method step of leaving a predefined clearance, namely a safety clearance between the conductive strip and an edge of the ceramic-based panel. During mounting and dismantling of the ceramic-based panel, the probability of contact to the conductive strips is high. Thus, the probability of electric shock when the user contacts the edge sections of the ceramic-based panel is prevented. The safety clearance is at least 1 mm.

In another possible application of the present invention, there is the method step of coating the conductive strips by means of one each insulator layer which are resistant to abrasion. There is no electric shock risk at very low voltages in case of DC current, however, there is electric shock risk in case of AC current. Thus, the probability of electric shock which occurs when the user manually contacts the conductive strips on the ceramic-based panel is prevented.

In another possible application of the present invention, there is the method step of coating the conductive strips by means of one each decorative layers. Thus, a pattern may be obtained on the conductive strips and this pattern can be observed on the ceramic-based panel. The decorative layer can be obtained by means of a painting method.

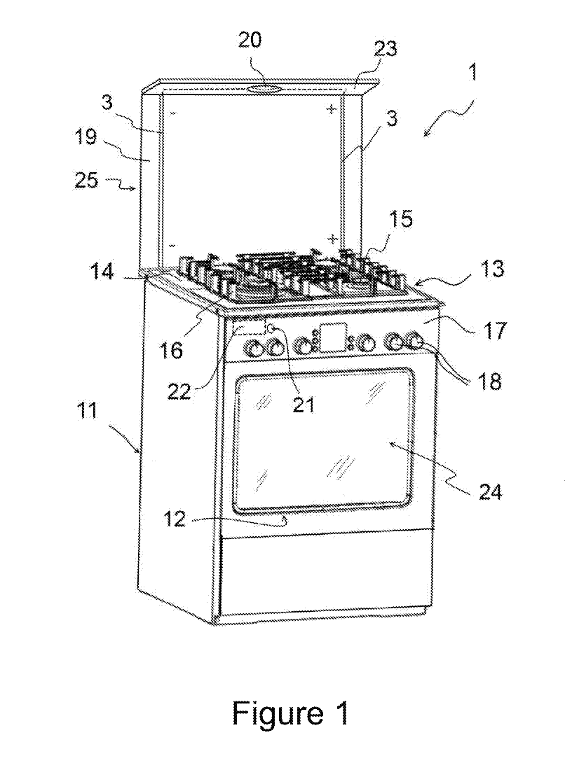

FIG. 1 is a frontal perspective view of a cooking device having a ceramic-based panel and having electrical transmission elements on the ceramic-based panel.

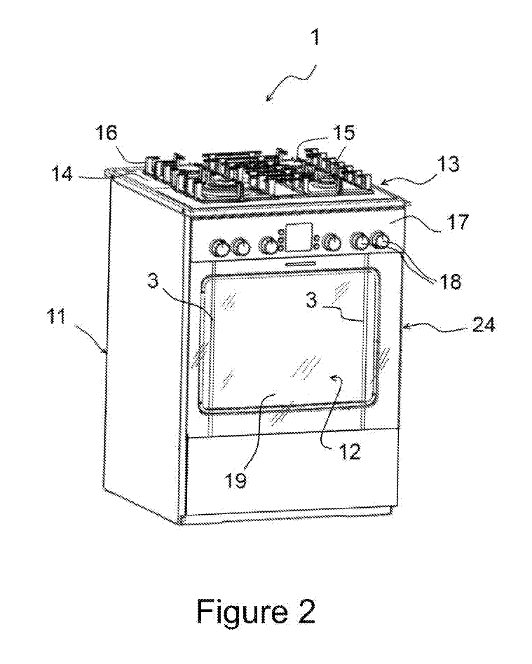

FIG. 2 is a frontal perspective view of an alternative cooking device.

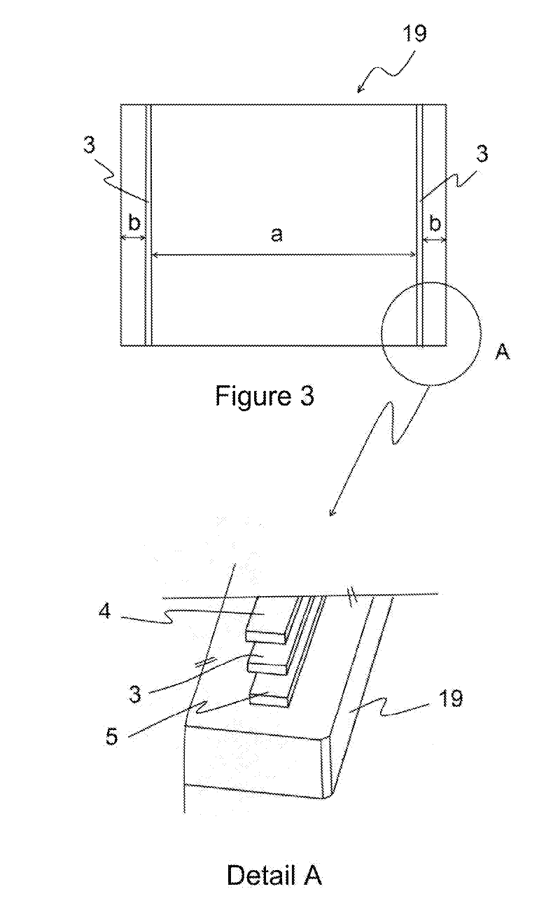

FIG. 3 is a frontal two-dimensional view of a ceramic-based panel whereon the subject matter electrical transmission elements are provided.

Detail A is taken from FIG. 3 and it is the view of a subject matter electrical transmission element and the layers thereof on the ceramic-based panel where said layers are separated from each other.

Detail B is the view where the layers, illustrated in Detail A, are in joined form.

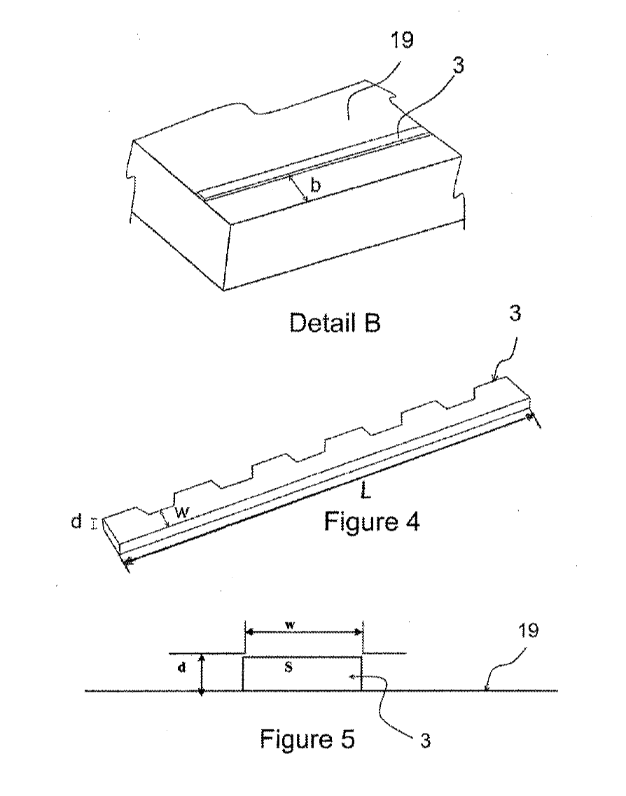

FIG. 4 is a perspective view of an electrical transmission element in an alternative subject matter design.

FIG. 5 is the view of a required minimum cross section of the subject matter electrical transmission element.

The present invention relates to a cooking device (1) where electrically safe electrical transmission is provided, without the need for additional elements like a cable and a carrier profile which provides cable safety.

The cooking device (1) can be in the form of a standalone cooktop or it can be in the form of an oven having at least one cooking chamber (12). Or it can be in the form of an oven with cooktop where both are provided in the same body (11) (FIG. 1, FIG. 2). There is a plate (14) where the cooktop (13) of such a cooking device (1) is installed. The plate (14) is integrated on the body (11). On the plate (14), there are burners (15), and a carrier grid (16) which is able to carry a cooking pan. There is a control panel (17) on a front section of the body (11) which is easily accessible. On the control panel (17), buttons (18) are positioned which provide burner gas output to be adjusted or which provide the required adjustments for the cooking chamber to be made.

In FIG. 1 and FIG. 2, a subject matter cooking device (1) and an alternative cooking device (1) solution are illustrated.

FIG. 1 is a frontal perspective view of a cooking device (1) having a ceramic-based panel (19) and electrical transmission elements on the ceramic-based panel (19) which provide transmission of low voltage electricity. Said ceramic-based panel (19) illustrated in the figure can be in the form of a door (24) placed in an openable-closeable manner to the section of the cooking device (1) which provides access to the cooking chamber (12), and/or it can be in the form of a cover (25) opened to one side of the plate (14) of the cooktop (13) and which covers the plate (14) when required. In FIG. 1, a cooking device (1) is illustrated where the door (24) and the cover (25) of the plate (14) are made of ceramic. An upper profile (23) is positioned along an upper edge of the ceramic-based panel (19) which is in cover form. The upper profile (23) is made of metal material.

FIG. 2 is a frontal perspective view of an alternative cooking device (1). In FIG. 2, a cooking device (1) is illustrated which has no cover (25). The ceramic-based panel (19) is produced in the form of a cover (25) which covers the cooking chamber (12).

FIG. 3 is a frontal two-dimensional view of a ceramic-based panel (19) whereon the subject matter electrical transmission elements, providing electrical transmission at low voltage, are provided.

Said electrical transmission elements are one each conductive strips (3). One of the conductive strips (3) is negatively charged at both ends, and the other one is positively charged at both ends. One side of the conductive strips (3) can be coated with an insulator material, and the other side thereof can be coated with serigraphy paint. By means of this, a conductive strip (3) turns into a layered structure (FIG. 3, Detail A). Ceramic-based panels (19) are made of ceramic materials, and particularly made of glass materials.

In more details, the operation of the present invention is as follows. The conductive strips (3), which transmit electricity, are negatively and positively charged, and they transmit power to a functional element (20). The functional element (20) operates at low voltage. For instance, it can be a LED illumination source, a signal or indicator lamp, or it can be a button which operates by means of power. The power, provided from a power supply (22), is guided to the conductive strips (3), and by means of this, power is transmitted to the functional element (20). The power, supplied from the power supply, is the power supplied from the mains by means of cables. The cables may be directly connected to the conductive strips (3), or instead of that, an electronic card may be used.

A triggering element (21) has been installed for turning on/off the functional element (20). The triggering element (21) may be a touch-button or a mechanical button. Or it may be an element which functions by means of audible commands.

As can be seen in FIG. 1, an application of the present invention is realized by means of passing conductive strips (3) through a ceramic-based panel (19) which is in the form of a cover (25) of a cooktop (13) plate (14). During the usage of the cooktop (13), in general, the ceramic-based panel (19) is kept open. The conductive strips (3), passed through the ceramic-based panel (19), transmit power to a functional element (20) which can be positioned on or in the vicinity of the ceramic-based panel (19). In an application of the invention as in FIG. 1, the functional element (20) is placed on the upper profile (23) provided on the ceramic-based panel (19). Thus, power is transmitted to the upper profile (23) and to the functional element (20) through the upper profile (23). The conductive strips (3) can be passed also through the cooktop (13) plate (14) by providing the required thermal preservation and by providing the desired aesthetical appearance. The location, where power shall be transmitted, can also be close to the door (24) of the cooking device (1). In this case, the conductive strips (3) are passed through the door (24). The conductive strips (3) can be passed through the cover (25) and through the door (24). In an application of the present invention, as can be seen from FIG. 2, the conductive strips (3) are passed only through the door (24).

Voltage is transmitted through different lines, whose both ends are electrically insulated from each other, on the ceramic-based panel (19). Therefore, if AC (alternative current) is to be passed, the phase (+ and − charges) and the neutral lines are formed by conductive strips separately, and if DC (direct current) is to be passed, the negatively and positively charged lines are formed by separate conductive strips. Therefore, short-circuit is prevented. The electronic card (22) converts AC voltage to DC voltage which has the desired properties. Although the current input is not fixed, a fixed DC is obtained at the output thanks to the design of the electronic card (22). In other words, if the desired output is 5V DC, a different electronic card (22) is used, and if the desired output is 10V DC, a different electronic card (22) is used. Said output is an end of the conductive strip (3) which extends to the functional element (20) or which is directly connected. The voltage value passing through the conductive strips (3) is between 0 and 60 volts. Current is provided with a voltage which is higher than the voltage value which shall reach the functional element (20). The reason of this is that voltage losses along the conductive strip (3) are inevitable by taking the length and the cross section of the conductive strip (3) as a base. A cross section (S) of the conductive strip (3) alters depending on the type of the voltage as AC or DC, the voltage amount (U), the power (N), and a line distance (L) which is the length of the conductive strip.

The conductive strips (3) are selected from metal materials like silver, copper having electrical conductivity. Conductive strips (3) are needed which have different cross sectional thicknesses and lengths depending on the current and power to be drawn from the line, the distance of electrical transmission, voltage type (AC or DC). Said variables facilitate determination of the cross sectional area (S) of the conductive strips (3) provided on the ceramic-based panel (19), they moreover facilitate determination of the distance on the ceramic-based panel (19) and the distance with respect to one edge of the ceramic-based panel (19). In case the thickness of the conductive strip (3) is insufficient, voltage decreases since power loss occurs depending on the distance.

The voltage loss on the conductive strip (3) can be calculated according to the following formula;

$$Voltage Loss \% = kaybi = \frac{100 * L * N}{K * S * {U}^{2}}$$

L: Line distance/length of the conductive strip (m),

N: Power (kW),

K: Conductivity coefficient (m/Ω mm²),

S: Conductor cross section (mm²),

U: Voltage (V).

The cross section of the conductive strip (3) is S=d.w.

d; the height/thickness of the conductive strip (3), w; width (FIG. 5).

After the required minimum cross sectional area (S) and the minimum width (w) of the conductive strip (3) are provided, the desired geometrical form or pattern can be obtained on the conductive strip (3) (FIG. 4).

By using the abovementioned formula, the amount of power which is required to be provided by the power supply can be determined by means of an example as given below. Let us calculate the voltage loss in case a conductive strip (3), comprising silver ion with width (w) of 1 mm², with thickness of 0.01 mm, is passed through a ceramic-based panel (19) with length of 0.595 m, and in case the conductive strip (3) has 5 V voltage with power of 2 W;

$$x \% = \% x = \frac{100 * 0.595 * 0.002}{9.7 * {10}^{- 3} * 0.01 * {5}^{2}}$$

X=49, in this case, as can be seen in the result occurring, the 49% of the voltage is lost before reaching the functional element (20). This is not a desired situation. Therefore, in order to reduce the voltage loss to an acceptable level, the cross sectional area (S) of the conductive strip (3) is taken as 5 mm² by increasing the width (w) to 5 mm such that the thickness (d) is kept fixed at 0.01 mm.

For S=5 mm², the calculation is as follows;

$$y \% = \% y = \frac{100 * 0.595 * 0.002}{9.7 * {10}^{- 3} * 0.05 * {5}^{2}}$$

Y=9,8, in this case, the voltage loss is an acceptable value. Thus, the type of the material from which the conductive strip (3) is produced and the dimension of the cross section (S) have critical importance for the transmission of electricity. Since the principle value is the critical cross sectional area (S), the thickness (d) of the conductive strip (3) is increased, and the width (w) can be reduced or kept fixed.

In case a DC type current is used, if the power supply, providing DC signal, is produced as SELV (safety extra low voltage/separated extra low voltage), the upper side of the conductive strip (3) does not need to be insulated. Since the voltage will be very low, it is not sensed when touched from outside, in other words, no electric shock occurs.

The power supply, shortly named as SELV, distributes the power provided by means of a converter or an equivalent insulation device, and it is a secondary circuit which does not have a direct connection with the AC primary supply. In a switch mode between AC-DC, it is a low-voltage power supply. For instance, it can be set at 48V DC output so as to be suitable for maximum 60V DC for the SELV power supply. In case of SELV usage, a leakage does not lead to electric shock risk.

If an AC type current is to be used, the conductive strips (3) must be insulated. Therefore, the conductive strip (3) is coated by an insulator material so as to form an insulator layer (4). The insulator material may be a paint, enamel coating, etc., which has insulator properties and which is resistant to scratching and which is resistant to abrasive cleaning substances.

The insulator layer (4) may be coated onto the outward facing side of the conductive strip (3), or it may also be coated onto the side thereof facing the ceramic based panel (19). By means of this, electrical insulation is provided, and moreover, color and design alternatives can be used which allow making design. A decorative layer (5), which is the uppermost layer, can be formed whereon for instance serigraphy can be applied for providing aesthetic visual appearance. The decorative layer (5) can be provided under or above the conductive strip (3) in a visible manner from another face of the ceramic-based panel (19).

The fixation of the conductive strips (3) onto the ceramic-based panel (19) is provided by means of coating the material, forming the conductive strip (3), onto the ceramic-based panel (19). In an alternative embodiment of the present invention, different fixation methods can be utilized. The conductive strip (3) can be coated with insulator layer (4) and/or decorative layer (5) before it is coated onto the ceramic-based panel (19). The conductive strips (3) can be adhered onto the ceramic-based panel (19) by means of an adhesive. A safety clearance (b), which is the distance of the conductive strips (3) with respect to an edge of the ceramic based panel (19), is left as a predefined clearance. This clearance is at least 1 mm. Moreover, between the two conductive strips (3), a clearance (a) shall be left such that the conductive strips (3) do not contact each other.

The ceramic-based panel (19) is made of a tempered or non-tempered glass material. In the alternative embodiments of the present invention, it can be made of different ceramic materials. The wall thickness of the ceramic-based panel (19) may be variable.

One of the conductive strips (3) is fixed to one side of the ceramic-based panel (19), and the other one is fixed so as to be close to another corresponding side. In the alternative embodiments of the present invention, it may also be a straight line such that a determined clearance is provided in between, or it may be formed in different shapes, it may have an aesthetically visual design. The phase, entering through each conductive strip (3), exits through the same line; in other words, if AC phase (+charge) enters through the line, it exits as AC phase (+charge). Therefore, heating does not occur on the conductive strips (3).

Since an electrical transmission element with low voltage is used, for instance, it becomes possible to operate functional elements (20) like low-power motors and illumination systems. Since a non-cabled voltage transmission can be provided, an appropriate conductive material and an appropriate line thickness are selected, and all of the desired AC and DC systems can be operated.

In contradiction to a cable line, the lines, which are in the form of conductive strips (3), are resistant to breakages. By means of fixation on the ceramic-based panel (19), the breakage problems are prevented.

In case DC voltage is transmitted, and provided that the power supply is the system called SELV system, the user can safely touch the conductive strips (3) having low voltage. Thus, it is a safe system. It has a long lifetime, and it does not need special maintenance.

### REFERENCE NUMBERS

1. Cooking device
11. Body
12. Cooking chamber
13. Cooktop
14. Plate
15. Burner
16. Carrier grid
17. Control panel
18. Button
19. Ceramic-based panel
20. Functional element
21. Triggering element
22. Electronic card
23. Upper profile
24. Door
25. Cover
3. Conductive strip
4. Insulator layer
5. Decorative layer
a: Distance between two conductive strips
b: Safety clearance

1-18. (canceled)

19. A cooking device, comprising:
a body;
at least one functional element positioned on the body;
a ceramic-based panel positioned on an outer section of the body; and
at least one conductive strip directly passed through the ceramic-based panel so as to transmit electricity to the functional element through the ceramic-based panel.

20. The cooking device of claim 19, wherein the at least one conductive strip is only electrically positively or negatively charged.

21. The cooking device of claim 19, further comprising a further one of said at least one conductive strip, with one of the conductive strips being positively charged and the other one of the conductive strips being negatively charged, said conductive strips being connected to the functional element so as to complete an electrical circuit.

22. The cooking device of claim 19, wherein the conductive strips are supplied with a voltage value between 0 and 60 volts.

23. The cooking device of claim 19, further comprising an electronic card connected to the at least one conductive strip so as to transmit electrical current to the at least one conductive strip and converting the electrical current from AC to DC.

24. The cooking device of claim 21, wherein the conductive strips are supplied with a DC current.

25. The cooking device of claim 19, wherein the at least one conductive strip is made of metal material comprising Ag ion.

26. The cooking device of claim 19, further comprising an insulator layer applied on the at least one conductive strip and configured to be resistant to abrasion.

27. The cooking device of claim 19, further comprising a decorative layer applied upon the at least one conductive strip.

28. The cooking device of claim 19, wherein the functional element is an illumination element.

29. The cooking device of claim 19, further comprising a triggering element configured to turn on/off a power transmitted to the at least one conductive strip.

30. The cooking device of claim 19, wherein the at least one conductive strip has a cross section that is variable in an inversely proportional manner with a voltage applied to the at least one conductive strip, said at least one conductive strip having a conductivity coefficient that is in a directly proportional manner with a distance through which power and electrical current are desired to be transmitted.

31. A method, comprising coating an upper section of a ceramic-based panel of a cooking device with at least one metallic conductive strip to enable passage of electrical current through the ceramic-based panel.

32. The method of claim 31, further comprising:
applying a further metallic conductive strip upon the upper section of the ceramic-based panel in spaced-apart relationship to the at least one conductive strip,
connecting the conductive strips to a functional element positioned on the cooking device, and
positively charging one of the conductive strips and negatively charging the other one of the conductive strips to thereby establish an electrical circuit for transmitting electrical energy to the functional element.

33. The method of claim 31, wherein the at least one conductive strip is a paint.

34. The method according claim 31, wherein the at least one conductive strip is coated upon the upper section of the ceramic-based panel at a clearance to an edge of the ceramic-based panel.

35. The method of claim 31, further comprising applying an insulator layer upon the at least one conductive strip which is resistant to abrasion.

36. The method of claim 31, further comprising applying a decorative layer upon the at least one conductive strip.
